(19) United States
(12) Patent Application Publication
(10) Pub. No.: US 2018/0141873 A1
(43) Pub. Date: May 24, 2018

(54) METHOD FOR MAKING BZ HIGH-TEMPERATURE COLORED GLAZE PORCELAIN PLATE PAINTING

(71) Applicant: Li Zhang, Jilin (CN)

(72) Inventor: Li Zhang, Jilin (CN)

(21) Appl. No.: 15/559,056

(22) PCT Filed: Oct. 28, 2015
(86) PCT No.: PCT/CN2015/093049

§ 371 Date: Feb. 7, 2018

(30) Foreign Application Priority Data
Apr. 20, 2015 (CN) 201510187563.0

(51) Int. Cl. C04B 41/86; C04B 41/89; C04B 41/52; C04B 41/00; C04B 33/24; C09C 1/00; B44C 1/00

(52) U.S. Cl. CPC C04B 41/86; C04B 41/89; C04B 41/526; C04B 2111/82; C04B 33/24; C09C 1/0009; B44C 1/005; C04B 41/0072

(57) ABSTRACT

A high-temperature color glaze painting pigment includes a color glaze, white toning glaze and colorless toning glaze, wherein the color glaze consists of 50 wt % to 66 wt % high temperature resistant white glaze mineral and 50 wt % to 34 wt % water, the white toning glaze consists of 70 wt % high temperature resistant white glaze mineral and 30 wt % water, and the colorless toning glaze consists of 30 wt % high temperature resistant colorless glaze mineral and 70 wt % water, wherein the weight ratio of the color glaze to the white toning glaze is 12.5:1 to 50:1, the weight ratio of the color glaze to the colorless toning glaze is 20:1 to 100:1. The high temperature colored glaze painting pigment and a method for making a porcelain plate painting thereof can be not only manually completed by artists with their experiences, but completed by an industrial production way.

### (a) TECHNICAL FIELD OF THE INVENTION

The present invention relates to a ceramic technology, and more particularly to a high-temperature colored glaze painting pigment and a method for making a porcelain plate painting thereof.

### (b) DESCRIPTION OF THE PRIOR ART

Painting materials as an element of painting are an important part of painting art; and different materials express different artistic languages in decorative paintings to generate different vision effects. Recently, with the development of industrial technologies, new painting materials increasingly emerge. The innovation of new materials promotes the development of painting art and supports artists to explore artwork styles and painting techniques continuously. Through a harmonious combination of materials and surprising performance of skills, new visual languages are created, making artwork more expressive and artistic appeal.

The perspective of aesthetic of traditional paintings is to have accurate planar model, complete visual space, and elegant and multi-layered colors, while new painting materials change the traditional aesthetic perspective of people; the focus of painting is also shifted from pure hand-painting to the attention to make a picture, including the sense of form and dimension of artwork. People try to use the external characteristics and internal physical and chemical characteristics of new painting materials to carry out the making of painting artwork, and the form of expression is converted from traditional “artists speaking with materials” to “artists making materials speak”.

At the end of the 1950's of the twentieth century, the former Soviet Union scientists Boris Belousov and Anatol Zhabotinskii discovered in a chemical experiment that the chemicals that participate in the reaction seem to have macroscopically received some sort of uniform order, and exhibit a self-organization phenomenon of the color or to form consistent behavior in space and time when some appropriate conditions are satisfied. The phenomenon is called “chemical oscillation”, and also referred to as “BZ reaction” by selecting the first letters of the names of the two scientists.

High-temperature colored glaze porcelain plate painting of Jingdezhen is a modern creation made in Jingdezhen. The porcelain plate painting, which is classified as color-over-glaze, color-under-glaze, and high-temperature color glaze, is a traditional craft from ancient times. The high-temperature color glaze has risen for nearly half a century.

The existing art of high-temperature color glazed porcelain plate painting, which is fired at a high temperature of 1,300 degrees to 1,500 degrees, exhibits color change of the color glaze, turning into more vivid variety of saturated colors, but all the pigment is not blending, unlike other kinds of painting, such as painting, gouache, and watercolor, blending between color glazes being not pure and unsaturated.

### SUMMARY OF THE INVENTION

To overcome the defects mentioned above, the present invention is proposed.

According to one aspect of the present invention, a high-temperature color glaze painting pigment includes a color glaze, a white toning glaze and a colorless toning glaze, wherein the color glaze consists of 50 wt % to 66 wt % of high-temperature resistant color glaze mineral and 50 wt % to 34 wt % of water, the white toning glaze consists of 70 wt % of high-temperature resistant white glaze mineral and 30 wt % of water, and the colorless toning glaze consists of 30 wt % of high-temperature resistant colorless glaze mineral and 70 wt % of water, wherein the weight ratio of the color glaze to the white toning glaze is 12.5:1 to 50:1, the weight ratio of the color glaze to the colorless toning glaze is 20:1 to 100:1.

Preferably, the color glaze is selected from the group consisting of a red glaze, yellow glaze, blue glaze, green glaze, violet glaze, orange glaze or cyan glaze, wherein the red glaze consists of 55 wt % of red glaze mineral and 45 wt % of water, the yellow glaze consists of 50 wt % of yellow glaze mineral and 50 wt % of water, the blue glaze consists of 60 wt % of blue glaze mineral and 40 wt % of water, the green blaze consists of 58 wt % of green glaze mineral and 42 wt % of water, the violet glaze consists of 65 wt % of violet glaze mineral and 35 wt % of water, the orange glaze consists of 63 wt % of orange glaze mineral and 37 wt % of water, and the cyan glaze consists of 66 wt % of cyan glaze mineral and 34 wt % of water; the weight ratio of the red glaze to white toning glaze to colorless toning glaze is 500:10:5, the weight ratio of the yellow glaze to white toning glaze to colorless toning glaze 500:15:10, the weight ratio of the blue glaze to white toning glaze to colorless toning glaze 500:20:15, the weight ratio of the green glaze to white toning glaze to colorless toning glaze 500:25:20, the weight ratio of the violet glaze to white toning glaze to colorless toning glaze 500:30:15, the weight ratio of the orange glaze to white toning glaze to colorless toning glaze 500:35:20, and the weight ratio of the cyan glaze to white toning glaze to colorless toning glaze 500:40:25.

According to another aspect of the present invention, a method for making a high-temperature colored glaze porcelain plate painting includes:

stirring kaolin clay and water mixed at a weight ratio of 7:3 into a blank form, pressing the blank form into porcelain plates of various sizes, and then dried the porcelain plate without being directly exposed to sunlight;

mixing different high-temperature resistant minerals with water according to the following weight ratios to respectively form into red glaze, yellow glaze, blue glaze, green glaze, violet glaze, orange glaze and cyan glaze:

the weight ratio of the red glaze mineral to water is 55%:45%,

the weight ratio of the yellow glaze mineral to water is 50%:50%,

the weight ratio of the blue glaze mineral to water is 60%:40%,

the weight ratio of the green glaze mineral to water is 58%:42%,

the weight ratio of the violet glaze mineral to water is 65%:35%,

the weight ratio of the orange glaze mineral to water is 63%:37%, and

the weight ratio of the cyan glaze mineral to water is 66%:34%;

adding respectively a white toning glaze and a colorless toning glaze in each of said color glazes according to the following weight ratios, the white toning glaze consisting of 70 wt % of high-temperature resistant white glaze mineral and 30 wt % of water, and the colorless toning glaze consisting of 30 wt % of high-temperature resistant colorless glaze mineral and 70 wt % of water:

the weight ratio of the red glaze to white toning glaze to colorless toning glaze is 500:10:5,

the weight ratio of the yellow glaze to white toning glaze to colorless toning glaze is 500:15:10,

the weight ratio of the blue glaze to white toning glaze to colorless toning glaze is 500:20:15,

the weight ratio of the green glaze to white toning glaze to colorless toning glaze is 500:25:20,

the weight ratio of the violet glaze to white toning glaze to colorless toning glaze is 500:30:15,

the weight ratio of the orange glaze to white toning glaze to colorless toning glaze is 500:35:20, and

the weight ratio of the cyan glaze to white toning glaze to colorless toning glaze is 500:40:25;

painting each of the color blazes including at least the red glaze, yellow glaze and blue glaze added with the white toning glaze and colorless toning glaze on the porcelain plate without being directly exposed to sunlight in a sequence of the red glaze, yellow glaze, blue glaze, green glaze, violet glaze, orange glaze and cyan glaze; and

firing the colored porcelain plate at high temperature.

Preferably, the thickness of the porcelain plate is ranged from 2 to 3 centimeters.

Preferably, time for the drying without being directly exposed to sunlight is about one week.

Preferably, the firing is carried out at high temperature in a gas kiln, an electric kiln or a firewood kiln.

Preferably, the high temperature for firing the colored porcelain plates is controlled at 500 to 600 degrees on the first day, 600 to 800 degrees on the second day and 1300 to 1350 degrees on the third day, stopping the firing and cooling the fired porcelain plate naturally at room temperature.

The present invention discloses a composition which can be used as a painting material; and all the ingredients of the composition are readily available in the market. The ingredient components are mixed in accordance with appropriate ratios and used according to the steps and process conditions disclosed in the present invention so as to obtain an artwork of an irregular pattern. A number of pieces of the artworks have been put in auction markets and achieve good returns. Further, the technical solution disclosed in the present invention is also applicable to decoration industries, such as formation of background walls, making it high in market value. Furthermore, the operation of each painting material composition and painting work made according to the present invention can be achieved by experienced handwork and can be also produced in an industrialized manner by taking advantage of modern industrial technology, providing a variety of ways for the production of such artworks.

The creation and innovation of the “BZ Art” high-temperature colored glazed porcelain plate paintings solves the issue of blending and penetration among glazes of colors to provide all the colors of the colorful world, adding charm of art to the world.

The creation and success of the “BZ Art” high-temperature color glaze are a technical revolution throughout history, not only changing the integration between various color glazes but also making the colors purer, more saturated, and more gorgeous.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a picture of a BZ art high-temperature colored glaze porcelain plate painting painted by a preferred embodiment according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The present invention is generated from multimedia experiments carried out under a unique “BZ Art” theoretical system; various conventional glaze colors of high-temperature colored glaze porcelain plate paintings are not integrated and independent before the present invention is proposed. In a high-temperature colored glaze porcelain plate painting of the present invention, the glaze colors are integrated; they are of endless variation, the hues thereof are saturated, and the fission thereof is uniform like oil painting, gouache, watercolor and other pigments.

A method for making a “BZ Art” high-temperature colored glaze porcelain plate painting according to the present invention has the following steps:

adding kaolin clay (especially Jingdezhen local kaolin) with water, mixing at a ratio of 7:3 and stirring them into a blank form, and pressing the blank form with an iron rod or the like into plates of varying sizes flat as mirrors, which has thicknesses ranged from 2 to 3 centimeters, and then drying said porcelain plate without being directly exposed to sunlight about one week;

forming a variety of color glazes by mixing pure natural high-temperature resistant minerals with water at a certain ratio:

red glaze mineral is mixed with water at a ratio of 55%:45%,

yellow glaze mineral is mixed with water at a ratio of 50%:50%,

blue glaze mineral is mixed with water at a ratio of 60%:40%,

green glaze mineral is mixed with water at a ratio of 58%:42%,

violet glaze mineral is mixed with water at a ratio of 65%:35%,

orange glaze mineral is mixed with water at a ratio of 63%:37%, and

cyan glaze mineral water is mixed with at a ratio of 66%:34%;

adding a white toning glaze and colorless toning glaze into every kind of color glaze mentioned above after it is obtained, wherein the white toning glaze consists of 70 wt % of high-temperature resistant white glaze mineral and 30 wt % of water, and the colorless toning glaze consists of 30 wt % of high-temperature resistant colorless glaze mineral and 70 wt % of water, wherein

each 500 g red glaze is added with 10 g of white toning glaze and 5 g of colorless toning glaze,

each 500 g yellow glaze is added with 15 g of white toning glaze and 10 g of colorless toning glaze,

each 500 g blue glaze is added with 20 g of white toning glaze and 15 g of colorless toning glaze,

each 500 g green glaze is added with 25 g of white toning glaze and 20 g of colorless toning glaze,

each 500 g violet glaze is added with 30 g of white toning glaze and 15 g of colorless toning glaze,

each 500 g orange glaze is added with 35 g of white toning glaze and 20 g of colorless toning glaze, and

each 500 g cyan glaze is added with 40 g of white toning glaze and 25 g of colorless toning glaze,

The various high-temperature color glaze painting material obtained with the above-listed ratio, which are applied to porcelain plate painting, allows for integration of the various colors, making the colors purer, more saturated, and more gorgeous, this being also included in the protection scope pursued by the present invention.

Then, the variety of color glaze that are added with white toning glaze and colorless toning glaze are used for painting by following the following steps and sequence: firstly, painting red glaze, yellow glaze, blue glaze, green glaze, purple glaze, orange glaze, and cyan glaze respectively on dried porcelain plates. Of course, the above content provides just the most preferred way of embodiment. Similarly, using only some of the color glazes, including at least red, yellow, and blue colors, added white toning glaze and colorless toning glaze, following the above provided ratio and painting sequence, may also achieve the same BZ artistic effect.

The preferred time for making high-temperature color glazed porcelain plate painting is between September and October in Jingdezhen, where the temperature and humidity of this time are best for making the porcelain painting.

Kiln firing is preferred done with a gas kiln, and less preferred being an electric kiln and a wood kiln. The temperature for firing of the porcelain plate in the first day is controlled a high temperature of 500-600 degrees, the second day being controlled at a high temperature of 600-800 degrees, the third day being controlled at a high temperature of 1,300-1,350 degrees, and after that, burning for firing is stopped to allow for natural cooling in the kiln for three to four days until the temperature gets close to the outside temperature, when the product can be removed out of the kiln.

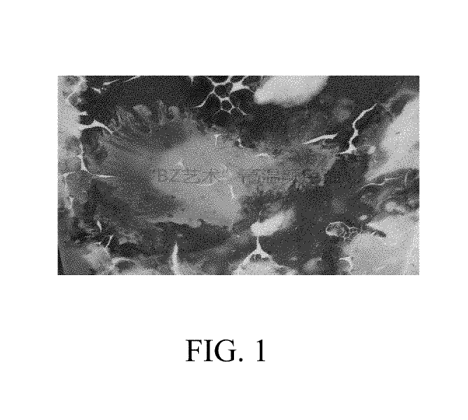

The general appearance of a BZ art high-temperature colored glaze porcelain plate painting made according to the embodiment is exemplified in FIG. 1.

The creation and innovation of the “BZ Art” high-temperature colored glazed porcelain plate paintings solves the issue of blending and penetration among glazes of colors to provide all the colors of the colorful world, adding charm of art to the world.

The creation and success of the “BZ Art” high-temperature color glaze are a technical revolution throughout history, not only changing the integration among various color glazes but also making the colors purer, more saturated, and more gorgeous.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

1: A high-temperature color glaze painting pigment, comprising a color glaze, a white toning glaze and a colorless toning glaze, wherein said color glaze consists of 50 wt % to 66 wt % of high-temperature resistant color glaze mineral and 50 wt % to 34 wt % of water, said white toning glaze consists of 70 wt % of high-temperature resistant white glaze mineral and 30 wt % of water, and said colorless toning glaze consists of 30 wt % of high-temperature resistant colorless glaze mineral and 70 wt % of water, wherein the weight ratio of said color glaze to said white toning glaze is 12.5:1 to 50:1, the weight ratio of said color glaze to said colorless toning glaze is 20:1 to 100:1.

2: The high-temperature color glaze painting pigment according to claim 1, wherein said color glaze is selected from the group consisting of a red glaze, yellow glaze, blue glaze, green glaze, violet glaze, orange glaze or cyan glaze, wherein said red glaze consists of 55 wt % of red glaze mineral and 45 wt % of water, said yellow glaze consists of 50 wt % of yellow glaze mineral and 50 wt % of water, said blue glaze consists of 60 wt % of blue glaze mineral and 40 wt % of water, said green blaze consists of 58 wt % of green glaze mineral and 42 wt % of water, said violet glaze consists of 65 wt % of violet glaze mineral and 35 wt % of water, said orange glaze consists of 63 wt % of orange glaze mineral and 37 wt % of water, and said cyan glaze consists of 66 wt % of cyan glaze mineral and 34 wt % of water; the weight ratio of said red glaze to white toning glaze to colorless toning glaze is 500:10:5, the weight ratio of said yellow glaze to white toning glaze to colorless toning glaze is 500:15:10, the weight ratio of said blue glaze to white toning glaze to colorless toning glaze is 500:20:15, the weight ratio of said green glaze to white toning glaze to colorless toning glaze is 500:25:20, the weight ratio of said violet glaze to white toning glaze to colorless toning glaze is 500:30:15, the weight ratio of said orange glaze to white toning glaze to colorless toning glaze is 500:35:20, and the weight ratio of said cyan glaze to white toning glaze to colorless toning glaze is 500:40:25.

3: A method for making a high-temperature colored glaze porcelain plate painting, comprising:
stirring kaolin clay and water mixed at a weight ratio of 7:3 into a blank form, pressing said blank form into a porcelain plate of various sizes, and then dried said porcelain plate without being directly exposed to sunlight;
mixing different high-temperature resistant minerals with water according to the following weight ratios to respectively form red glaze, yellow glaze, blue glaze, green glaze, violet glaze, orange glaze and cyan glaze:
the weight ratio of said red glaze mineral to water is 55%:45%,
the weight ratio of said yellow glaze mineral to water is 50%:50%,
the weight ratio of said blue glaze mineral to water is 60%:40%,
the weight ratio of said green glaze mineral to water is 58%:42%,
the weight ratio of said violet glaze mineral to water is 65%:35%,
the weight ratio of said orange glaze mineral to water is 63%:37%, and
the weight ratio of said cyan glaze mineral to water is 66%:34%;
adding respectively a white toning glaze and a colorless toning glaze in each of said color glazes according to the following weight ratios, said white toning glaze consisting of 70 wt % of high-temperature resistant white glaze mineral and 30 wt % of water, and said colorless toning glaze consisting of 30 wt % of high-temperature resistant colorless glaze mineral and 70 wt % of water:
the weight ratio of said red glaze to white toning glaze to colorless toning glaze is 500:10:5,
the weight ratio of said yellow glaze to white toning glaze to colorless toning glaze is 500:15:10,
the weight ratio of said blue glaze to white toning glaze to colorless toning glaze is 500:20:15,
the weight ratio of said green glaze to white toning glaze to colorless toning glaze is 500:25:20,
the weight ratio of said violet glaze to white toning glaze to colorless toning glaze is 500:30:15,
the weight ratio of said orange glaze to white toning glaze to colorless toning glaze is 500:35:20, and
the weight ratio of said cyan glaze to white toning glaze to colorless toning glaze is 500:40:25;
painting each of said color glazes comprising at least said red glaze, yellow glaze and blue glaze added with said white toning blaze and colorless toning blaze on said porcelain plate without being directly exposed to sunlight in a sequence of said red glaze, yellow glaze, blue glaze, green glaze, violet glaze, orange glaze and cyan blaze; and
firing said colored porcelain plate at a high-temperature.

4: The method according to claim 3, wherein the thickness of said porcelain plate is ranged from 2 to 3 centimeters.

5: The method according to claim 3, wherein time for said drying without being directly exposed to sunlight is about one week.

6: The method according to claim 4, wherein time for said drying without being directly exposed to sunlight is about one week.

7: The method according to claim 5, wherein said firing is carried out at a high temperature in a gas kiln, an electric kiln or a firewood kiln.

8: The method according to claim 6, wherein said firing is carried out at a high temperature in a gas kiln, an electric kiln or a firewood kiln.

9: The method according to claim 3, wherein said colored porcelain plate is carried out said firing at the high temperature, the high temperature for firing is controlled at 500 to 600 degrees on the first day, the second day is controlled at the temperature of 600 to 800 degrees, the third day is controlled at the temperature of 1300 to 1350 degrees, and then said firing is stopped to naturally cool the porcelain plate to room temperature.
